(19) United States
(12) Patent Application Publication
(10) Pub. No.: US 2026/0301759 A1
(43) Pub. Date: Oct. 1, 2026

(54) METHOD AND SYSTEM FOR CLASSIFYING AN ACOUSTIC ENVIRONMENT

(71) Applicant: DOLBY LABORATORIES LICENSING CORPORATION

(72) Inventors: Yu-Tin CHAO, Taipei (TW); Jundai SUN, Beijing (CN); Zhiwei SHUANG, Beijing (CN); Yuanxing MA, Beijing (CN)

(73) Assignee: DOLBY LABORATORIES LICENSING CORPORATION, (US)

(21) Appl. No.: 19/489,876

(22) PCT Filed: May 24, 2024
(86) PCT No.: PCT/US2024/030988

§ 371 Date: Dec. 3, 2025

Related U.S. Application Data
(60) Provisional application No. 63/518,313, filed on Aug. 8, 2023.

(30) Foreign Application Priority Data
Jun. 7, 2023 (WO) PCT/CN2023/098880

(51) Int. Cl. G10L 25/27; G06N 20/00; G10L 25/03

(52) U.S. Cl. CPC G10L 25/27; G06N 20/00; G10L 25/03

(57) ABSTRACT

According to an aspect there is provided a method for acoustic environment classification using a classifier trained to, given an input formed of a sequence of a number n of sets of acoustic features, output a prediction of an acoustic environment of an audio signal. The method comprises extracting sets of acoustic features from the audio signal. The method further comprises forming an input sequence of n sets of acoustic features, wherein forming the input sequence comprises: defining a base sequence of k of the extracted sets of acoustic features; defining an auxiliary sequence of d sets of acoustic features formed by one or more further instances of one or more of the k sets of acoustic features of the base sequence, wherein k<n and d=n−k; and combining the base sequence and the auxiliary sequence to form the input sequence of n sets of acoustic features. The method further comprises generating by the classifier a prediction of the acoustic environment using the n sets of acoustic features of the input sequence as input.

### CROSS-REFERENCE TO RELATED APPLICATIONS

This application claims priority to U.S. Provisional Patent Application No. 63/518,313 filed Aug. 8, 2023 and International Application No. PCT/CN 2023/098880 filed on Jun. 7, 2023, both of which are incorporated herein by reference.

### TECHNICAL FIELD OF THE INVENTION

The present invention relates to a method and system for classifying an acoustic environment.

### BACKGROUND

Acoustic environment or scene classifiers are used in audio processing for classifying an acoustic environment of an audio signal. An acoustic environment classifier may be implemented using machine-learning techniques and trained to output a prediction of an acoustic environment (e.g. a type of acoustic environment) based on an input of acoustic features extracted from an audio signal. By way of example, a classifier may be trained to classify an acoustic environment of an audio signal as silence or noise (e.g. moderate or very noisy). However, a classifier may also be trained to provide a more specific and semantic classification of audio signals, such as talk, music, traffic, car, bus, train, city center, park etc.

Acoustic environment classifiers are typically configured to provide the prediction based on input audio of a certain required minimum duration which is fixed (i.e. static or pre-determined) during training. That is, a typical classifier is trained to provide the prediction given an input sequence of a fixed number of acoustic features (i.e. an input sequence of a fixed length) extracted from an input audio signal. To provide accurate results, the required audio input duration for such “fixed-input length classifiers” generally tends to be relatively long, e.g. at least a few seconds, typically about 10 seconds, such that the required number of features may be extracted therefrom.

### GENERAL DISCLOSURE OF THE INVENTION

In view of the above, it may be noted that the typical input audio durations used for fixed-input length acoustic environment classifiers requires a large memory. Additionally, in case only an audio signal of less than the required input duration is available (e.g. since the audio signal is too short or since audio capture is on-going and has not yet reached the required input duration), classification of the audio environment has to be delayed until an audio signal of sufficient duration is available to the classifier.

Based on the above, it is therefore an object of the present invention to provide a method and system for acoustic environment classification which at least partly mitigates the above discussed drawbacks associated with acoustic environment classifiers based on an audio input of a fixed, and possibly relatively long (e.g. a few seconds or more), duration.

According to a first aspect of the present invention, there is provided a method for acoustic environment classification using a classifier trained to, given an input formed of a sequence of a number n of sets of acoustic features, output a prediction of an acoustic environment of an audio signal. The method comprises extracting sets of acoustic features from the audio signal, wherein each set of acoustic features comprises one or more types of acoustic features and is extracted from a respective time segment of a sequence of time segments of the audio signal. The method further comprises forming an input sequence of n sets of acoustic features, wherein forming the input sequence comprises:
defining a base sequence of k of the extracted sets of acoustic features;
defining an auxiliary sequence of d sets of acoustic features formed by one or more further instances of one or more of the k sets of acoustic features of the base sequence, wherein k<n and d=n−k; and
combining the base sequence and the auxiliary sequence to form the input sequence of n sets of acoustic features.

The method further comprises generating by the classifier a prediction of the acoustic environment using the n sets of acoustic features of the input sequence as input.

The first aspect is at least partly based on the insight that acoustic environment classification for an audio signal may be performed using a fixed-input length classifier by constructing an input sequence of the required integer number n of sets of acoustic features from a shorter than required base sequence of k<n of the extracted sets of acoustic features, and combining the base sequence with an auxiliary sequence formed by one or more further instances of one or more of the k sets of acoustic features of the base sequence. The one or more further instances of the sets of acoustic features are hence duplicates of the sets of acoustic features of the base sequence. Accordingly, one or more of the sets of acoustic features of the base sequence are duplicated one or more times in the input sequence such that the number of sets of acoustic features of the input sequence becomes n. The further instances of the sets of acoustic features (i.e. the duplicated acoustic sets of features of the auxiliary sequence) may be added to the base sequence, for instance by being appended and/or prepended thereto. The terms “set of acoustic features” may in the following for conciseness also be referred to as “feature set”.

The method hence employs the classifier to provide a prediction of the acoustic environment using fewer extracted feature sets than the fixed-input length classifier originally has been trained for.

The method thus allows for a more flexible use of a fixed-input length classifier.

Among others, the method enables classification of shorter audio signals as well as classification with reduced memory requirements (e.g. since a shorter audio signal than needed for the classification needs to be input, stored and processed for the feature extraction). The method also enables a reduced delay in providing a classification in case an audio signal of the required input duration has not yet been received and/or processed (e.g. since a sufficient number of time segments of the audio signal has not yet accumulated at a when the classification is to be made). The method confers this flexibility without the need to train classifiers for a plurality of different input lengths. Further merits of the method may be appreciated from the following.

In some embodiments, the method comprises iteratively performing classifications of the audio signal, wherein each classification relates to a respective temporal portion of the audio signal. Each classification comprises: forming a respective input sequence of n sets of acoustic features; and generating by the classifier a respective prediction of the acoustic environment for the respective temporal portion of the audio signal using the n sets of acoustic features of the respective input sequence as input. For each classification i (i.e. the classification of iteration i) the respective input sequence is formed in accordance with either a first mode or a second mode.

According to the first mode, the respective input sequence is formed by n sets of acoustic features extracted from a sequence of n time segments of the respective temporal portion of the audio signal.

According to the second mode, the respective input sequence is formed by:
defining a respective base sequence of ki sets of acoustic features extracted from a sequence of kᵢ<n time segments of the respective temporal portion of the audio signal,
defining a respective auxiliary sequence of dᵢ=n−kᵢ sets of acoustic features formed by one or more further instances of one or more of the kᵢ sets of acoustic features of the respective base sequence, and
combining the respective base sequence and auxiliary sequence to form the respective input sequence.

Multiple classifications of different temporal portions of the audio signal may hence be performed, wherein the approach for forming the input sequence may be varied between successive predictions of the audio environment. The first mode may be employed when n time segments of the audio signal is available, wherein n feature sets may be directly extracted and used as input to the classifier. If this is not the case, the input sequence may instead be formed from a base sequence of ki feature sets, with the advantages discussed above.

The method of the first aspect may also be used in conjunction with monitoring for a changed acoustic environment (“environment change detection”) to facilitate a reduced latency in providing a classification after a change from a previous to a new acoustic environment. Therefore, in some embodiments, the method further comprises: obtaining an indication that an acoustic environment of the audio signal is changed from a previous to a new acoustic environment at a time instant corresponding to an m-th time segment of the sequence of time segments of the audio signal, and is maintained for a threshold number h≥1 of time segments; wherein the k sets of acoustic features of the base sequence are extracted from k time segments from the m-th time segment of the audio signal and onwards, or subsequent to the m-th time segment of the audio signal. The base sequence may thus be formed from k feature sets extracted from k time segments relating to the new environment. Since feature sets from only k<n time segments are needed to form the input sequence, a prediction may be generated with a reduced delay relative the timing of the environment change, and with greater relevance to the new environment.

According to a second aspect of the present invention, there is provided a method for processing an audio signal, comprising: obtaining an audio signal; classifying an acoustic environment of the audio signal using the method according to the first aspect or any of the embodiments, implementations, variations and examples thereof, thereby generating a prediction of the acoustic environment; and processing the audio signal using an audio processing stage having at least one adjustable control parameter, wherein the at least one control parameter is set in dependence on the prediction of the acoustic environment. The advantages of the first aspect may hence be conferred to a method for processing an audio signal, wherein the classification of the audio environment is used to control the processing of the audio signal.

According to a third aspect of the present invention, there is provided a computer program product comprising computer program code to perform, when executed on a computer, the method according to the first aspect or any of the embodiments thereof.

According to a fourth aspect of the present invention, there is provided a system for acoustic environment classification. The system comprises a classifier trained to, given an input formed of a sequence of n sets of acoustic features (i.e. n feature sets), output a prediction of an acoustic environment of an audio signal. The system further comprises a feature extractor configured to extract sets of acoustic features from the audio signal, wherein each set of acoustic features comprises one or more types of acoustic features and is extracted from a respective time segment of a sequence of time segments of the audio signal. The system further comprises an input pre-processor configured to form an input sequence of n sets of acoustic features and provide the input sequence as input to the classifier to generate a prediction of the acoustic environment. The input pre-processor is further configured to form the input sequence by: defining a base sequence of k sets of acoustic features extracted by the feature extractor, defining an auxiliary sequence of d sets of acoustic features formed by one or more further instances of one or more of the k sets of acoustic features of the base sequence, wherein k<n and d=n−k, and combining the base sequence and the auxiliary sequence to form the input sequence of n sets of acoustic features.

The invention according to the third and fourth aspects features the same or equivalent benefits as the invention according to the first aspect. Any functions described in relation to the first aspect, may have corresponding features in a system and vice versa.

### BRIEF DESCRIPTION OF THE DRAWINGS

Embodiments of the present invention will now be described in more detail with reference to the appended drawings.

FIG. 1 is a block diagram of a user device and a classification system according to some implementations.

FIG. 2 schematically depicts a feature extractor of the classification system performing feature extraction from time segments of an input audio signal.

FIG. 3 is a block diagram depicting the classification system in operation, according to some implementations.

FIG. 4 is a flow chart of a method for acoustic environment classification according to some implementations.

FIG. 5 schematically illustrates an approach for forming an input sequence.

FIG. 6 is a flow chart of a method for an iterative acoustic environment classification according to some implementations.

FIG. 7 illustrates an audio signal being subjected to acoustic environment classification according to the method of FIG. 6.

FIG. 8 is a flow chart of sub-steps of a classification step of FIG. 6.

FIG. 9 is a flow chart of a method for processing an audio signal, according to some implementations.

FIG. 10 is a flow chart of a method comprising an environment change detection.

FIGS. 11 and 12 illustrate example approaches for forming the input sequence subsequent to an environment change detection.

FIG. 13 is a flow chart of a method corresponding to an extension of the method of FIG. 10.

FIG. 14 illustrates an audio signal subjected to acoustic environment classification according to the method of FIG. 13.

### DETAILED DESCRIPTION

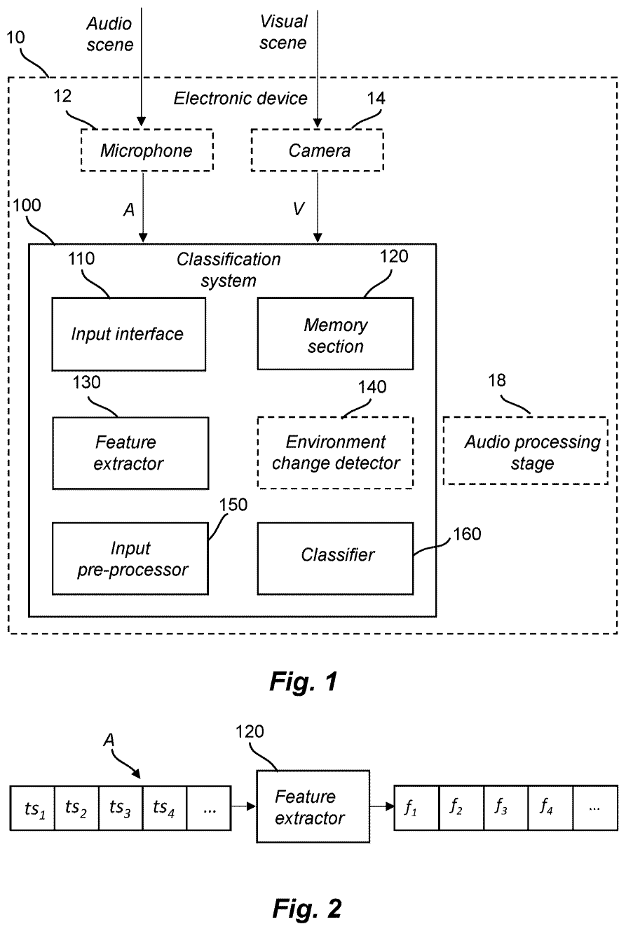

FIG. 1 depicts among others a classification system 100 comprising a memory section 120, a feature extractor 130, an input pre-processor 150 and a classifier 160. The classifier 160 is a fixed-input length classifier. That is, the classifier 160 is trained to output a prediction P of an acoustic environment in which an input audio signal A is captured, given an input sequence of a number n of sets of acoustic features (n feature sets). The feature sets are extracted from the audio signal A by the feature extractor 130. The extracted feature sets are provided to the input pre-processor 150 which (after enough acoustic feature sets have been accumulated) may combine the extracted feature sets to form an input sequence of feature sets of the required length (i.e. n). The detailed operation of the input pre-processor 150 and various manners of combining extracted feature sets to form the input sequence is described in further detail below. The input sequence may subsequently be provided as input to the classifier 160 to provide a prediction of the acoustic environment of the audio signal A.

The audio signal A may, as shown in FIG. 1, be received from a microphone system 12 comprising one or more microphones capturing audio of an audio scene. The audio signal A may be captured and provided to the classification system 100 in real-time, but may also be recorded and stored, and provided to the classification system 100 for classification at a later time. The classification system 100 may more generally typically be agnostic to the actual source of the audio signal A, and may accordingly be used to classify audio signals regardless of their source (e.g. captured in real-time capture or being pre-recorded). The audio signal A may in either case be received by an input interface 110 of the classification system 100. The received audio signal A may be stored in a memory section 120 of the classification system 100 to allow subsequent signal processing and classification, as set out below. If the originally captured audio signal is a stereo or multi-channel capture, the audio signal may optionally first be converted to mono prior to being provided to the classification system 100. This may facilitate the signal processing of the classification system 100 (e.g. the feature extraction), e.g. in case the configuration of microphones used to capture the audio signal A is not a priori known.

The classifier 160 may be trained to provide a multi-class prediction of the acoustic environment. That is, the classifier 160 may be trained to classify an input audio signal into one of a plurality of acoustic environment classes (acoustic scene classes). By way of example, the classifier 160 may be trained to provide a semantic classification of audio signals, such as talk, music, traffic, car, bus, train, city center, park etc. However, also less complex classifications are possible such as merely providing a rating of a noise level of the environment, e.g. by semantic labels such as “low noise level”, “moderate noise level”, “high noise level”, or in terms of a numeric rating on a suitable predefined scale, as a non-limiting example on a scale from 1 to 5, where a higher rating indicates a higher noise level.

The classifier 160 may be implemented using typical machine-learning techniques such as a Gaussian Mixture Model (GMM), a Hidden Markov Model (HMM), support vector machines (SVMs), k-nearest neighbor (kNN) classifiers. The classifier 160 may also be implemented using trained artificial neural networks, such as convolutional neural networks (CNN) and Recurrent Neural Networks (RNN). The classifier 160 may be trained by extracting feature sets from a training set of audio signals recorded in a number of different acoustic environments, feeding the feature sets to the classifier 160 and updating the model parameters (e.g. in the case of a neural network the weights) to minimize an error between the prediction output by the classifier 160 and the labels of the acoustic environments recorded in the training set. One example of a training dataset is “the TAU Urban Acoustic Scenes 2020 Mobile, development data set” (or earlier versions) containing recordings of 10-second durations from 10 different acoustic scenes: airport, indoor shopping mall, metro station, pedestrian street public square, street with medium level of traffic, travelling by a tram, travelling by a bus, travelling by an underground metro, urban park. This is merely one non-limiting example of a training set and other training sets may also be used. Training of machine-learning models and artificial neural networks of the aforementioned types is per se known in the art and will hence not be described in further detail herein.

The feature extraction proceeds by the feature extractor 130 receiving the audio signal A and extracts a sequence of feature sets therefrom, such that each feature set of the sequence is extracted from a respective time segment of a corresponding sequence of time segments of the audio signal A. The term “time segment” here refers to a temporal period or slice of the audio signal A, while the term “sequence of time segments” accordingly refers to a time-series of time segments or temporal periods (slices), i.e. successive time segments, typically consecutive time segments of the audio signal A. It is further herein assumed that each time segment of the sequence is of a same and pre-defined duration. The precise value of the duration is dependent on the type of acoustic feature(s) being extracted as well as the sample rate of the audio signal A. For instance, the extracted feature sets may be frame-level features wherein each feature set is extracted from a respective frame of a sequence of frames of the audio signal A. In this case, the number n of the input sequence would hence correspond to the number of single frame-level feature sets the classifier 160 expects as input in order to provide a prediction. By way of example, an audio signal sampled at a rate of 48 kHz may be divided into frames of 1024 samples, corresponding to frame duration of about 21.3 ms. Given an audio signal of about 10 seconds, the feature extractor 130 may thus extract a sequence of about 470 feature sets from a sequence of a corresponding number of frames.

It is however to be noted that acoustic features also may be extracted from time segments with a duration different from the duration of a single frame. For instance, a sequence of n feature sets may be extracted from a sequence of n time segments of the audio signal A, wherein each time segment corresponds to a respective sub-sequence of two or more frames of the audio signal A. Each of the n feature sets of the sequence may hence be extracted from two or more frames (i.e. a multi-frame feature set). Also time segments with a sub-frame duration are possible, wherein each time segment may correspond to a respective subset of successive (e.g. consecutive) samples of the audio signal A. The number n of feature sets expected as input by the classifier 160 may typically correspond to feature sets extracted from an audio signal of a duration of at least 2 seconds, or at least 4 seconds, for instance (approximately) 8, 9, 10 seconds or more.

FIG. 2 schematically depicts the feature extractor 130 extracting sets of acoustic features f₁, f₂, f₃ . . . from a sequence of time segments ts₁, ts₂, ts₃ . . . of audio signal A, wherein each feature set f_{j=1,2,3} . . . is extracted from the correspondingly numbered time segment ts_{j=1,2,3} . . . . In view of the above, each time segment ts₁, ts₂, etc. is of a same duration and may be formed by one or more frames, or a number of samples, of the audio signal A.

Acoustic feature types relevant for acoustic environment classification include for example time-frequency features, such as short-time a Fourier spectrum, a delta spectrum, Mel-frequency cepstral coefficients (MFCC), delta MFCC, a log-Mel spectrum, or a delta log-Mel spectrum. Further examples of acoustic feature types include e.g. energy-level, zero crossing rate, spectral bandwidth, etc. According to one example, a sequence of n feature sets may be formed by a time-series of n number of log-Mel spectrums computed for 128 or 256 frequency bins. With reference to FIG. 2, this corresponds to a sequence of feature sets f₁, f₂, . . . , fₙ, each comprising a 128 or 256 frequency bin log-Mel spectrum extracted from a respective time segment. Such a sequence of feature sets may be represented by a 2-dimensional array or matrix, e.g. with dimension 128×n (or 256×n in the case of 256 frequency bins), which may be provided as input to the classifier 160.

The classifier 160 may be trained to classify the acoustic environment based on feature sets comprising an acoustic feature of a single type. The feature extractor 130 may thus extract a single (and same) type of acoustic feature from each time segment of the audio signal A. However, the classifier 160 may alternatively be trained to classify the acoustic environment based on feature sets comprising acoustic features of two or more different types. The feature extractor 130 may in this case extract two or more different types of acoustic features (e.g. an acoustic feature of a first type and an acoustic feature of a second type) from each time segment of the audio signal A. Each feature set may hence define a “composite-type” feature set, in contrast to the “single-type” feature set mentioned above. Examples of such composite-type feature sets include: MFCC and a delta MFCC, a Fourier spectrum and a delta spectrum, or a log-Mel spectrum and a delta log-Mel spectrum (wherein it is to be understood that the features of each feature set is extracted from a same time segment of the audio signal A). According to one example, a sequence of n feature sets may be formed by a time-series of n number of log-Mel spectrums and delta log-Mel spectrums computed for 128 or 256 frequency bins. With reference to FIG. 2, this corresponds to a sequence of feature sets f₁, f₂, . . . , fₙ, each feature set comprising a 128 (or 256) frequency bin log-Mel spectrum and a 128 (or 256) frequency bin delta log-Mel spectrum extracted from a respective time segment. Such a sequence of feature sets may be represented by a multi-dimensional array or tensor data structure, e.g. with dimension 128×2×n (or 256×2×n in the case of 256 frequency bins), which may be provided as input to the classifier 160.

A scenario will now be considered wherein it is assumed that the classification system 100 has received an input audio signal A of a sufficient duration to allow the classifier 160 to classify the acoustic environment captured in the audio signal A. Accordingly, a sequence of at least n time segments of the audio signal A have been received by the classification system 100 and stored in the memory section 120. It is further assumed that the memory section 120 has sufficient available space to allow extraction and storing of an input sequence of n feature sets extracted from the time segments of the audio signal A. The feature extractor 130 may accordingly process the received sequence of time segments (e.g. sequentially) to extract a feature set from each of the time segments. When at least n feature sets have been extracted and stored, the input pre-processor 150 may form an input sequence of n of the extracted feature sets. If exactly n feature sets are available, the input sequence may be formed by these n acoustic features. If more than n feature sets are available, the input sequence may be formed of a subset of n feature sets derived from a selected part of the audio signal. The input pre-processor 150 may provide the input sequence as input to the classifier 160, wherein the classifier may generate a prediction of the acoustic environment.

The operations of the classification system 100 described under the scenario above, may be considered as a “normal mode” in the sense that enough audio data is available and stored in the memory section 120 for enabling the classifier 160 to generate a prediction. This also corresponds to a traditional use case for a fixed-input length classifier. Accordingly, traditionally, if not enough audio data is available, the classification either will be delayed until more audio data has been received, or no classification can be made. The “normal mode” may in the following also be referred to as the “first mode” of operation of the classification method and the classification system 100.

However, adopting the novel approach set out herein enables audio environment classifications using a fixed-input length classifier based on an amount of audio data which, traditionally, would be considered insufficient. More specifically the classification may be made based on fewer than the number n of feature sets the fixed-input length classifier has been trained for. This approach may in the following be referred to as the “second mode” of operation of the classification method and the classification system 100.

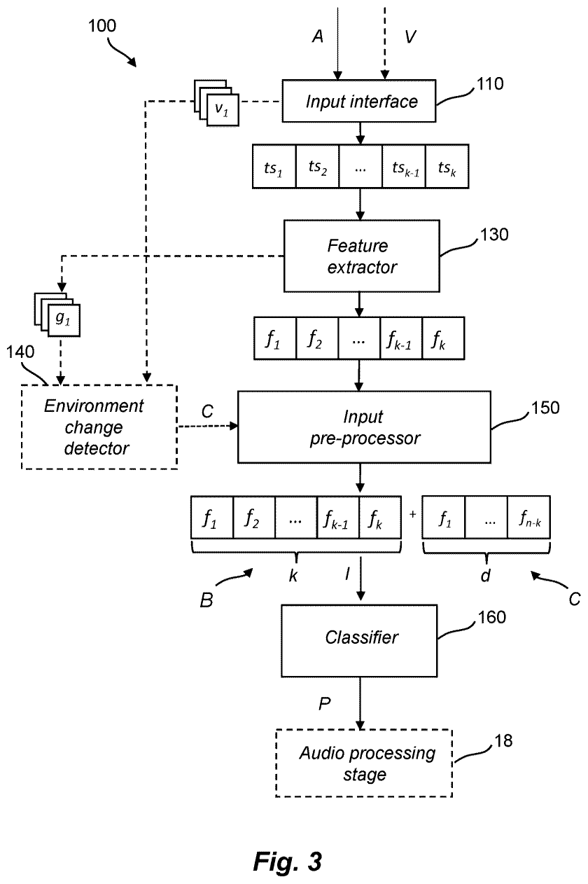

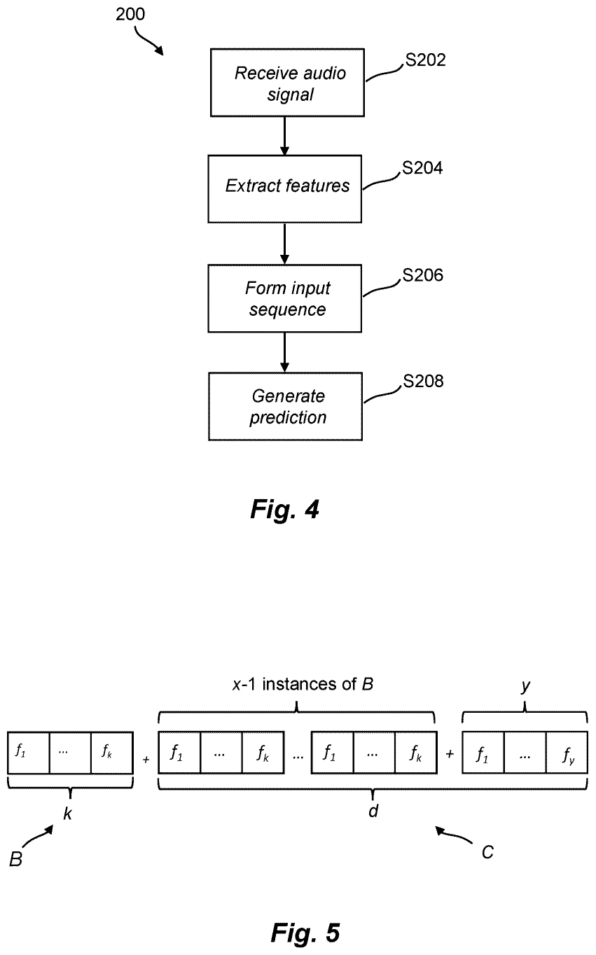

An implementation of the “second mode” will now be described with reference to the classification system 100 of FIG. 1, and further with reference FIG. 3 showing in further detail the operation of the classification system 100, and the flow chart of FIG. 4.

At step S202, the audio signal A is received by the input interface 110 of the classification system 100. In contrast to the scenario described in the preceding paragraphs, it will now be assumed that a sequence of only k<n time segments ts₁, ts₂, . . . , tsₖ, of the audio signal A have been received and stored when the input sequence I is to be formed by the input pre-processor 150. The k time segments may typically be k consecutive time segments of the audio signal A. The received time segments may be stored in the memory section 120 in preparation for the acoustic feature extraction.

At step S204, the feature extractor 130 extracts sets of acoustic features f₁, f₂, . . . , fₖ from the sequence of time segments ts₁, ts₂, . . . , tsₖ. As discussed above, either a single type of acoustic feature or two or more types of acoustic features may be extracted. In either case, each feature set f_{j=1 . . . k} is extracted from a respective one of the received time segments ts_{j=1 . . . k}. The extracted feature sets may be stored in the memory section 120. While FIG. 4 shows steps S202 and S204 as successive steps, it is to be noted that the steps S202 and S204 also may be performed in an interleaved fashion, wherein time segments ts_{j=1 . . . k} may be received and processed sequentially, i.e. in the order they are received. Optionally, each time segment ts_{j=1 . . . k} of the audio signal A may be temporarily buffered during the feature extraction and discarded once the feature extractor 130 has extracted the feature set therefrom.

At step S206, the input pre-processor 150 forms an input sequence I of n feature sets using the k extracted feature sets f_{j=1 . . . k}. First, a base sequence B is defined by k of the extracted feature sets. In the present example, the number of extracted feature sets is k and the input pre-processor 150 may hence simply form the base sequence B of the k extracted feature sets. Secondly, an auxiliary sequence C of d=n−k feature sets is defined. The number d hence corresponds to the number of feature sets (and time segments) which are missing relative the number n of feature sets expected by the classifier 14. The d feature sets of the auxiliary sequence C are formed by one or more further instances of one or more of the k feature sets f_{i=1 . . . k} of the base sequence B. Thirdly, the input pre-processor 150 forms the input sequence/by combining (e.g. concatenating) the base sequence B and the auxiliary sequence C.

At step S208, the input sequence/is provided as input to the classifier 160, wherein the classifier 160, using the n feature sets of the input sequence as input, generates a prediction P of the acoustic environment of the audio signal A, more specifically the type of acoustic environment captured in the time segments ts_{i=1 . . . k} of the audio signal A.

Various approaches for forming the auxiliary sequence C are possible: In the illustrated example of FIG. 3, the auxiliary sequence C is formed by a sub-sequence of d consecutive feature sets of the base sequence B, more specifically feature sets f_{i=1 . . . n-k} of the base sequence B. This corresponds to the first d feature sets of the base sequence B. However, it is also possible to form the auxiliary sequence C from the last d feature sets of the base sequence B. More generally, the auxiliary sequence C may be formed by any arbitrarily selected sub-sequence of d feature sets of the base sequence B. The selected d feature sets need not even be consecutive. It is even possible to select one or more feature sets of the base sequence B more than once, such that the auxiliary sequence C includes one or more duplicates of feature sets. It is however envisaged that it may be advantageous to form the auxiliary sequence C of d uniquely selected feature sets of the base sequence B to limit an amount of redundant feature sets in the input sequence I (provided this is possible, as discussed below). In either of these cases, d of the feature sets of the base sequence B will be duplicated once (or more) in the resulting input sequence I.

Various approaches are also possible for combining the base sequence B and the auxiliary sequence C: In the illustrated example of FIG. 3, the auxiliary sequence C is appended to the base sequence B. However, it is also possible to pre-pend the auxiliary sequence C to the base sequence B. More generally, the feature sets of the auxiliary sequence C may be appended and/or prepended to the base sequence B. For example, a first subset of the feature sets f_{i=1 . . . n-k} may be prepended to the base sequence B and a second subset of the feature sets f_{i=1 . . . n-k} may be appended. It is even possible to combine the base sequence B and the auxiliary sequence C such that the feature sets of the auxiliary sequence C are interleaved within the base sequence B. It is however envisaged that it may be advantageous to maintain the order of the feature sets of the base sequence B and the auxiliary sequence C, respectively, to preserve the relative temporal relationship between the feature sets within respective sequences as far as possible (e.g. to limit a risk of making prediction less reliable).

The above approaches for forming the auxiliary sequence C and for combining the base sequence B and the auxiliary sequence C have been discussed with an assumption that at most half (n/2) of the number of feature sets expected by the classifier 160 are missing. That is, the number of extracted feature sets k is equal to or greater than n/2. Under this assumption the auxiliary sequence C may be formed by a single further instance of at least a sub-sequence of length d selected from the base sequence B, as discussed above.

However, if more than half of the number of acoustic features expected by the classifier 160 are missing (i.e. if k<n/2), the auxiliary sequence C may instead be formed by x−1 further instances of the base sequence B and one (1) further instance of a sub-sequence (i.e. fraction) of the base sequence B of length y. The parameter x is here the greatest divisor of n and y is the remainder of n/k. An example of this approach is illustrated in FIG. 5 wherein an auxiliary sequence C is formed of x−1 instances of the base sequence B and y feature sets f_{i=1 . . . y} selected from the base sequence B. The auxiliary sequence C is then combined with the base sequence B to form the input sequence of length n. In the illustrated example the y feature sets f_{i=1 . . . y} of the auxiliary sequence C are further instances of the first y feature sets of the base sequence B. This is however merely an example, and the y feature sets may more generally be any arbitrarily selected sub-sequence of the base sequence B. Analogous to the above discussion of approaches for combining the base sequence B and the auxiliary sequence C, the feature sets of the auxiliary sequence C may be appended and/or prepended to the base sequence B, or interleaved with B.

Hence, if only k feature sets is available at a time when the audio signal A is to be classified (i.e. fewer than the n feature sets expected by the classifier 160), the classification system 100 may in accordance with the second mode supplement the available k feature sets with further instances of one or more feature sets selected from the k feature sets, so as to construct an input sequence of n feature sets. As realized by the inventors, this approach reduces the accuracy of the classification appreciably less than reducing the size of the classifier model (e.g. by training the classifier 160 based on fewer, e.g. n/2 feature sets). The loss of accuracy is also appreciably smaller than what may be achieved by modifying the feature extraction (e.g. the hop-length and the window size of the FFT) to increase the number of feature sets that may be extracted from an audio signal of a given duration.

While the novel approach (second mode) in principle is able to construct an input sequence of n feature sets based on a shorter base sequence of any non-zero number of feature sets, the accuracy of the classification tends to deteriorate more appreciably for base sequences of fewer than n/2 feature sets (although still comparing favorably to reducing the model size or the feature extraction as mentioned above). In an implementation of the second mode favoring accuracy over flexibility, the input pre-processor 150 may be configured to perform the step of forming the input sequence on a condition that a number of extracted feature sets available to the input pre-processor 150 (e.g. being stored in the memory section 120) is at least n/2. Otherwise, the input pre-processor 150 may be configured to postpone forming the input sequence until at least n/2 feature sets become available.

As mentioned above, the audio signal A received by the input interface 110 and the sets of acoustic features fⱼ extracted by the feature extractor 130 may be stored in the memory section 120 of the classification system 100. Received time segments tsⱼ of the audio signal A may be stored in an input buffer provided in the memory section 120. The feature extractor 130 may retrieve time segments tsⱼ from the input buffer (e.g. sequentially, one at a time) and extract the one or more types of acoustic features making up the feature set fⱼ therefrom. The extracted feature sets fⱼ may be stored in an output buffer provided in the memory section 120. While reference here is made to one and a same memory section 120, it is to be noted that the memory section 120 refers to the full memory resources which may be allocated to the classification system 100, whether implemented by a single or multiple different physical memory circuits. For instance, the input buffer and the output buffer may be implemented in software as virtual buffers agnostic to the underlying memory circuitry. In some example implementations, the input buffer may be allocated in a main memory or “state memory”. The output buffer may be allocated in a temporary memory (e.g. a “scratch” memory, a cache memory or another memory for temporary storage of the input to the classifier 160). The input pre-processor 150 may thus form and store (temporarily) the base sequence B and the auxiliary sequence C in the temporary memory. A space of sufficient size for storing the n feature sets of the input sequence I should hence be allocated in the temporary memory. The input sequence I may then be read (retrieved) from the temporary memory by the classifier 160. The input sequence I may then be wiped from the temporary memory (thus in effect being consumed by the classifier 160). In a variation of the above, the output buffer may instead be allocated in the main memory and the input pre-processor 150 may form and store the base sequence B and the auxiliary sequence C in the temporary memory. Providing the output buffer in a main memory enables re-use of extracted feature sets in subsequent classifications.

As an example, the classification system 100 may during operation receive and store a sequence of time segments tsj of the audio signal A in the input buffer (e.g. in a main memory). The sequence of time segments tsⱼ may here span the full duration of the input audio signal A, or correspond to a merely a temporal portion of the overall audio signal A. Time segments tsⱼ may be accumulated (i.e. buffered) until the input buffer is full, until a predetermined number of time segments have been buffered, or until the classification system 100 determines (e.g. responsive to an internally or externally generated trigger) that a classification of the (buffered portion) of the audio signal A is to be performed. The feature extractor 130 may thereafter proceed with extracting the feature sets fⱼ from the time segments tsj stored in the input buffer and store the extracted feature sets fⱼ in the output buffer (e.g. in a main memory or a temporary memory). The number of feature sets fⱼ that may be extracted is determined, at least in part, by the number of time segments tsⱼ stored in the input buffer. This may in turn be limited by the duration of the audio signal A, or the storage space of the memory section 120 available for storing received time segments tsⱼ of the audio signal A. (i.e. the size of the input buffer). Additionally, the number of feature sets fⱼ that may be extracted and stored may be limited by the storage space of the memory section 120 available for storing extracted feature sets fⱼ. Accordingly, as may be appreciated, the number of feature sets fⱼ that the feature extractor 130 may extract and store in the output buffer may vary in dependence on one or more of: a duration of the audio signal A, a memory capacity available for storing received time segments tsⱼ of the audio signal A and/or extracted feature sets fⱼ. For instance, received time segments tsⱼ and/or extracted feature sets fⱼ exceeding the sizes of the input buffer and output buffer, respectively, may be discarded. Alternatively, the input and output buffers may be implemented as respective data queues (e.g. a respective first-in-first-out data structure), such that when they become full, the first added time segment tsⱼ or feature set fⱼ is removed when a new time segment tsⱼ or feature set fⱼ is to be stored.

Consequently, in view of the foregoing, the number k may correspond to the duration of the received audio signal A (or portion thereof), or a memory capacity of the memory section 120 available for storing received time segments tsⱼ of the audio signal A and/or extracted sets of acoustic features fⱼ.

In any case, if only k<n extracted feature sets fⱼ are available for forming the input sequence, the input pre-processor 150 may still form an input sequence of n feature sets according to the second mode as discussed with reference to FIG. 3 (e.g. using a temporary memory with sufficient space allocated for storing the input sequence I). If (at least) n extracted feature sets fⱼ are available, the input pre-processor 150 may form an input sequence of n extracted feature sets fⱼ according to the first (“normal”) mode, as set out above.

A further merit of this approach is that since the auxiliary sequence C is formed by further instances of already extracted feature sets fⱼ of the base sequence B, the further/duplicate instances of the feature sets fⱼ may optionally be formed by referencing memory areas storing the extracted features (e.g. using pointers). The auxiliary sequence C may hence be formed without creating duplicate copies of originally extracted feature sets fⱼ. The d feature sets of the auxiliary sequence C may hence be represented more efficiently (i.e. by fewer bits) than d additional extracted feature sets. The classification method does however not preclude forming the further instances by actual copies of feature sets fⱼ of the base sequence B. The method may still facilitate a memory and computationally efficient classification since (i) acoustic features tend to require less storage space than the original audio data, and (ii) since the number of time segments to be processed during feature extraction may be reduced (i.e. for a classification only k time segments need be processed by the feature extractor 130 rather than n time segments).

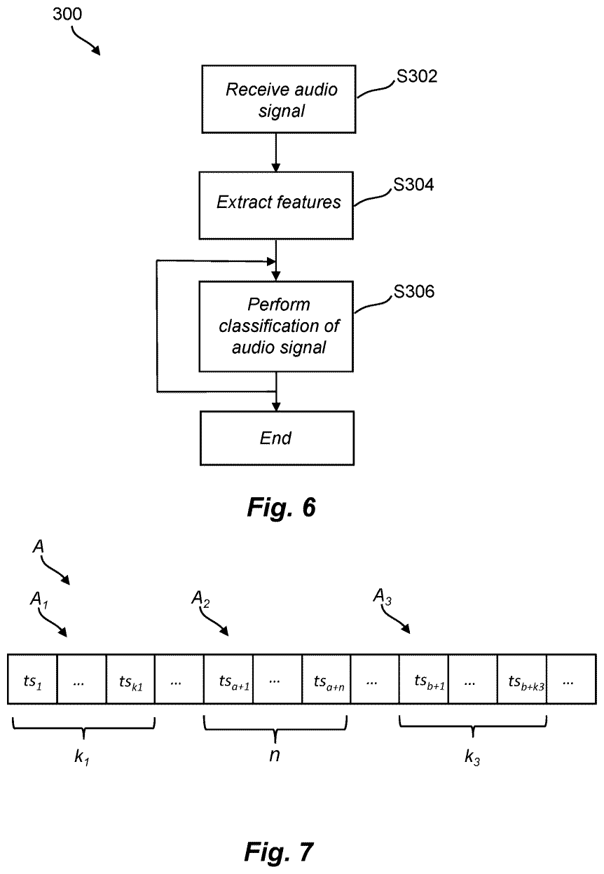

FIG. 6 is a flow chart of a method 300 for acoustic environment classification, wherein the classification system 100 iteratively performs classifications relating to respective temporal portions A₁, A₂, A₃ etc. of an audio signal A schematically depicted in FIG. 7.

Steps S302 and S304 of the method 300 generally corresponds to steps S202 and S204 of the method 200 of FIG. 4.

At step S306, the classification system 100 performs a classification of a respective temporal portion of the audio signal A. The classifications may be performed iteratively over the duration of the audio signal A, e.g. at a predetermined or variable interval or repetition frequency with respect to the sequence of time segments tsⱼ of the audio signal A. However, classifications may also be performed on-demand, e.g. responsive to a trigger condition such as a classification request received from an entity external to the classification system 100. In the illustrated example of FIG. 7, the temporal portions A₁, A₂, A₃ etc. are shown as non-overlapping in time, however it is envisaged that the classifications may be performed more frequently to classify overlapping temporal portions.

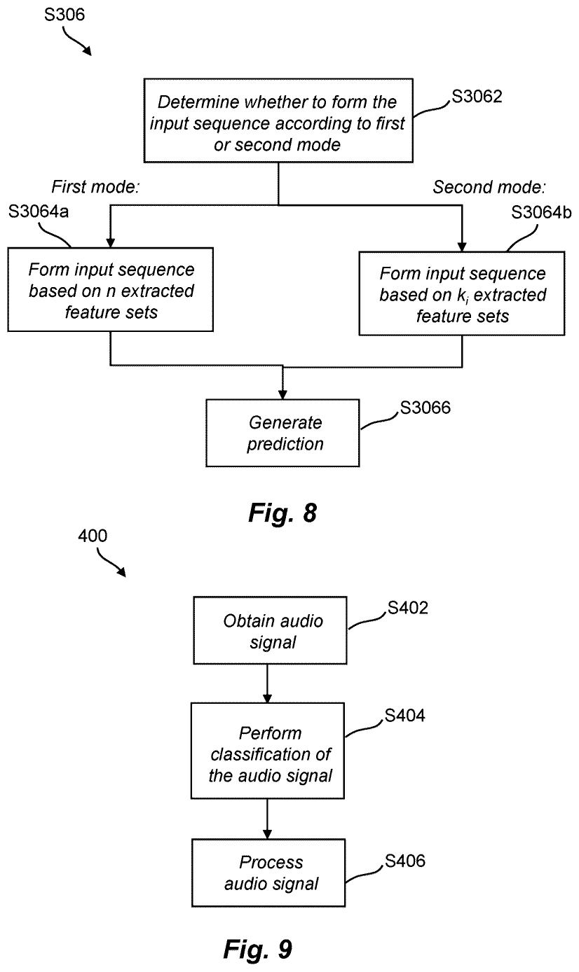

With reference to the flow chart of FIG. 8, there are shown sub-steps which may be performed as part of each respective classification i (i denoting the i-th iteration). At step S3062, the classification system 100 (for instance by the input pre-processor 150) determines whether to form a respective input sequence Iᵢ in accordance with either the first (i.e. “normal”) mode or the second mode. The determination may in line with the preceding description be based on a duration of the respective temporal portion Aᵢ and/or an available memory capacity for storing the time segments constituting the respective temporal portion and/or extracted acoustic features extracted from the time segments of the respective temporal portion Aᵢ.

As set out above, according to the first mode, the respective input sequence Iᵢ may at step S3064a be formed by n sets of acoustic features extracted from a sequence of n time segments of the respective temporal portion Aᵢ of the audio signal A.

As set out above, according to the second mode, the respective input sequence Iᵢ may at step S3064b be formed by:
defining a respective base sequence of kᵢ feature sets extracted from a sequence of kᵢ<n time segments of the respective temporal portion Aᵢ of the audio signal A,
defining a respective auxiliary sequence of dᵢ=n−kᵢ feature sets formed by one or more further instances of one or more of the kᵢ feature sets of the respective base sequence Bᵢ, and
combining the respective base sequence Bᵢ and auxiliary sequence Cᵢ to form the respective input sequence Iᵢ.

The approaches for forming the base sequence B, the auxiliary sequence C and the input sequence I discussed in connection with FIG. 3-5 apply correspondingly to present method.

Following either step S3064a or step S3064b, the input sequence I; may then be provided to the classifier 160 as input, wherein the classifier 160 at S3046 may generate a respective prediction of the audio environment captured in the respective temporal portion Ai.

It is envisaged that an available space of the memory section 120 may vary over the duration of the audio signal A, between successive classifications/iterations i. For instance, the first temporal portion A₁ may be shorter than n time segments (e.g. when the first classification is to be made, fewer than n time segments of the audio signal A have been received). Additionally or alternatively, an initially allocated size of the input and/or output buffers may need to be adjusted in run-time. Hence, the number kᵢ of time segments tsⱼ and/or feature sets fⱼ may be varied between successive iterations.

The environment classification system 100 may as shown in FIG. 1 be included in an electronic device 10. The electronic device 10 may for instance be a user device such as a smart phone, a tablet computer, a laptop or other portable or handheld electronic device, or a desktop computer. Other types of electronic devices are also possible such as a smart speaker, a TV set, a home entertainment system, a car audio system, etc.

Incorporating an acoustic environment classification system such as the system 100 in the electronic device 10 enables the electronic device 10 to classify an acoustic environment in an audio signal A obtained by the electronic device 10. The electronic device 10 may comprise an audio processing stage 18 for processing the audio signal A, wherein classifications (i.e. predictions output by the classifier 160) may be used to control the audio processing stage 18.

A method 400 for processing an audio signal A will now be described with reference to FIG. 1 and the flow chart of FIG. 9.

At step S402, the user device 10 obtains an audio signal A. The audio signal A may for instance be an audio signal captured by a microphone system 12 of the electronic device 10. The microphone system 12 may be comprised in a housing of the electronic device 10 or be an external microphone system connected to the user device (wirelessly or by wires). The microphone system 12 may for instance be comprised in one or both earpieces of a pair of earbuds or headphones. The audio signal A may also be received via other means, such as over a wired or wireless communication channel. The audio signal A may also be a pre-recorded audio signal, stored in a memory of the electronic device 10 and retrieved, e.g. for playback over a speaker system of the electronic device 10.

At step S404, the audio signal A, in whole or one or more temporal portions thereof, is input to the classification system 100 via the input interface 110 wherein the audio signal A (or the portions thereof) may be classified as set out above (e.g. by the method as shown in FIG. 4 or FIG. 6). The output of the classifier 160, i.e. the prediction P, may be provided as input to the audio processing stage 18 (as shown in FIG. 3).

At step S406, the audio signal A is processed by the audio processing stage 18, wherein at least one adjustable control parameter of the audio processing stage 18 may be set in dependence on the prediction of the acoustic environment. The audio processing stage 18 may implement various types of audio signal processing algorithms.

The audio processing stage 18 may be configured to process the audio signal A for noise suppression. A prediction P about the type of acoustic environment of the audio signal (or a portion thereof) may be indicative of the type and/or level of noise in the audio signal (or portion). The audio processing stage 18 may accordingly use the prediction P to adjust e.g. one or more of a type of noise suppression algorithm, an aggressiveness of a noise suppression algorithm (and optionally for which sub-bands), or other parameters controlling the noise suppression algorithm.

The audio processing stage 18 may additionally or alternatively be configured to process the audio signal A for dialogue enhancement, event detection and/or sound object extraction. A prediction P about the type of acoustic environment of the audio signal (or a portion thereof) may be indicative of e.g. what type of ambient sound, sound events and/or sound objects may be expected. The audio processing stage 18 may accordingly use the prediction P to adjust the algorithms to be primed for e.g. separating dialogue from the background, searching for the types of events and/or objects that may be expected, etc.

In either case, a prediction about the type of acoustic environment enables the audio processing stage 18 to be controlled with an aim of improving its output (e.g. a more efficient noise suppression, an improved separation between dialogue or sound objects and ambient sound, etc.).

It is contemplated that the electronic device 10 may use the classification system 100 to classify an audio signal A only once (such as an initial portion of the audio signal A), set the one or more control parameters of the audio processing stage 18 based on the single prediction P, and thereafter process the entire audio signal A without further adjustments of the control parameter(s). It is however also possible to iteratively perform classifications of respective temporal portions of the audio signal A (e.g. using the method 200 of FIG. 6) and alter the control parameter(s) in response to a changed prediction P.

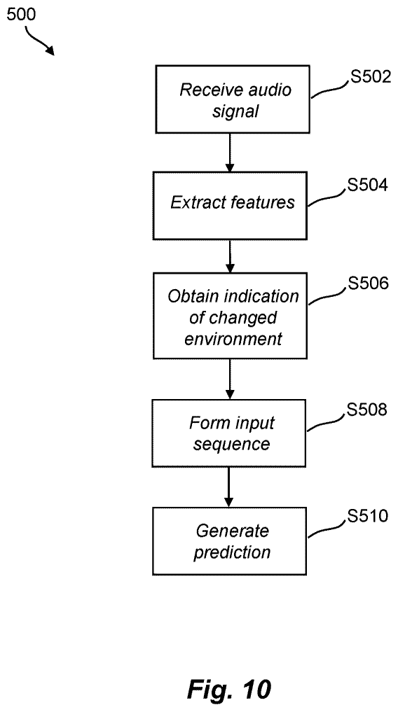

Performing a full classification (e.g. semantic) of an audio signal using the classifier 160 as described above, may be relatively computationally expensive. Additionally, providing a reasonably reliable prediction typically requires storing and processing of audio data of at least a couple of seconds. However, as realized by the inventors, a mere detection that the acoustic environment has changed (e.g. from a first type to a second type) may be implemented in a more computationally and memory efficient manner. Therefore, a method combining a classification based on the above discussed second mode with an “environment change detection” will now be described with reference to FIG. 1 and FIG. 10.

Steps S502 and S504 of the method 500 generally correspond to steps S202 and S204 of the method 200 of FIG. 4. Accordingly, at step S502 time segments tsⱼ of an audio signal A (or a portion thereof) is received by the input interface 110 of the classification system 100. At step S504, the feature extractor 130 extracts feature sets fⱼ from the received time segments tsⱼ.

As shown in FIG. 1, the classification system 100 may comprise an environment change detector 140. At step S506, the environment change detector 140 obtains an indication that the acoustic environment is changed at a time instant corresponding to (e.g. coinciding or overlapping with) an m-th time segment tsⱼ₌ₘ of the received sequence of time segments tsⱼ of the audio signal A, and is maintained for a threshold number h≥1 of time segments ts_{j>m} following time segment tsₘ. More specifically, the indication obtained indicates a change from a previous acoustic environment to a new acoustic environment (i.e. different from the previous environment). Accordingly, based on the indication of the changed environment it may be assumed that time segments prior to the m-th time segment (i.e. ts_{j<m}) relate to the previous acoustic environment, while time segments from the m-th time segment and onwards (i.e. ts_{j≥m}) relate to the new environment. The threshold number h (which may be referred to as a “holding parameter”) may be a predetermined or configurable parameter set to reduce a risk of confusing temporary or spurious changes in the features (see below discussion) used as decision basis for the environment change detector 140 with an actual change of environment.

Therefore, at step S508 the input pre-processor 150 forms an input sequence/as set out for step S206 of the method 200, but where the base sequence B is defined by k sets of feature sets f_{j≥m} extracted from k time segments ts_{j≥m} including and subsequent to the m-th time segment. Accordingly, also the auxiliary sequence C is formed of feature sets firm extracted from time segments tsjem relating to the new environment.

At step S510, the input sequence/is provided as input to the classifier 160, wherein the classifier 160 generates a prediction P based on the feature sets f_{j≥m} of the input sequence I. Since the input sequence I is formed by combining the base sequence B and the auxiliary sequence D, also the input sequence I is formed of feature sets fem extracted from time segments ts_{j≥m} relating to the new environment.

According to the method 500, the prediction P is thus based on feature sets extracted only from time segments captured in the new environment. This enables a more reliable classification of the type of the new acoustic environment. Moreover, since feature sets from fewer than n time segments are needed to form the input sequence I, the prediction P may be generated with a reduced delay relative the timing of the environment change. Using a fixed-input duration classifier in a traditional manner in connection with acoustic environment changes could in contrast result in a prediction based on a sequence of feature sets extracted from time segments of the audio signal relating both to the previous and the new environment, thus reducing the reliability of the prediction. Alternatively, the prediction would need to be delayed until at least n time segments and feature sets have been received and extracted after the change.

As mentioned above, detecting a change from a previous to a new environment may be implemented in a more computationally and memory efficient manner than performing an actual full classification of an acoustic environment. Among others, an environment change detection may be based on less data, e.g. fewer and/or less complex features. A further and related benefit is that an environment change detection algorithm may be performed with a greater repetition rate (i.e. more frequently) than the acoustic environment classification with a comparably small impact on power consumption. As may be better understood from the following, an environment change detection may for instance be performed with a frequency corresponding to a temporal rate of the sequence of time segments (e.g. the frame rate of the audio signal A or some suitable fraction thereof). Various techniques for detecting a changed acoustic environment are set out in the following:

In some implementations, obtaining the indication of the changed environment may comprise determining a change of an acoustic feature between the m-th time segment and a previous time segment. The changed environment may thereby be detected on the basis of a change of an acoustic feature between a pair of successive (e.g. consecutive) time segments.

The acoustic features may comprise, or be derived from, the one or more types of acoustic features of the feature sets (e.g. fₘ₋₁ and fₘ) extracted by the feature extractor 130. It is however noted that the type of acoustic feature used for the environment change detection may be different from the type(s) of acoustic feature(s) of the feature sets.

The environment change detection may for instance be based on an acoustic feature type in the form of a noise level of or an energy level (e.g. within one or more selected sub-bands) determined or extracted from the time segments. This is schematically illustrated in FIG. 3, wherein the feature extractor 130, in addition to the feature sets fⱼ, extracts an acoustic feature gⱼ from each time segment tsⱼ. The sequence of acoustic features gⱼ is received by the environment change detector 140 which based thereon detects whether there is a change of an acoustic environment. For instance, the detector 140 may determine that the acoustic environment has been changed responsive to detecting that an acoustic feature deviates from a preceding acoustic feature, or a from base line (e.g. average, median, maximum, minimum) of a number of preceding acoustic features, by more than a threshold amount.

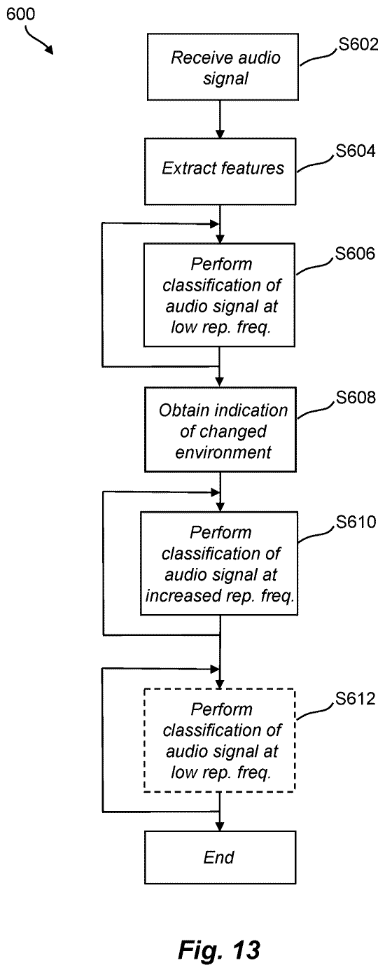

As mentioned above, the detector 140 may further determine whether the (presumed) new environment first detected at time segment tm (based on acoustic feature gₘ) is maintained for a threshold number h of time segments before finally determining that there has been a change of acoustic environment. The detector 140 may hence compare the h successive acoustic features to gₘ and, provided they are equal to gₘ within some margin of tolerance, finally determine that there has been a changed environment at time segment tₘ. The environment change detector 140 may responsive to the determination output an indication of the changed environment to the input pre-processor 150, as shown in FIG. 3, which in response may be caused to proceed according to the method 500 (or the method 600 of FIG. 13 discussed below).

In some alternative implementations, the environment change detection may instead be based on image data. Reference is now again made to the user device 10 in FIG. 1. Simultaneous to the user device 10 obtaining an audio signal A via the microphone system 12, the user device 10 may obtain, via a camera 14 of the user device 10, a sequence of image frames vⱼ of a video stream V simultaneous to obtaining the audio signal A. The video stream V may as shown be received by the input interface 110.

The simultaneous capture of video stream V and audio signal A may for instance be performed as part of a recording process of an audio-visual media stream. But other scenarios are also possible such as during conducting of a video conference from a smart phone, tablet computer, or other computing device with video conferencing functionality. As more specific and non-limiting examples, consider a user capturing an audio-visual media stream (e.g. as a vlog) during a city tour, or a user conducting a video-conference call using a mobile phone, where it may be expected that a change in visual information may be associated with a changed acoustic environment (e.g. due to the user moving between different environments, or vice versa).

Regardless of the specific use case, as further shown in FIG. 2, the sequence of image frames vⱼ may be received by the environment change detector 140. The environment change detector 140 may comprise, as a sub-component, a visual feature extractor extracting a respective visual feature qⱼ from each respective image frame vⱼ. The indication of the changed environment may be obtained by determining, at the environment change detector 140, a change of the visual feature between image frames corresponding to the m-th time segment and a previous time segment. The changed environment may thereby be detected on the basis of a change of a visual feature between a pair of successive (e.g. consecutive) time segments.

The environment change detection may for instance be based on a changed average (e.g. global or local) luminance level. An average luminance level represents a reliable and computationally efficient metric. However, also other types of detectors are possible such as a changed histogram, a changed contrast level (global or local), a changed location (i.e. motion) of one or more detected edges or objects in the frames, or combinations thereof.

Similar to the discussion of the environment change detection based on an acoustic feature type, the environment change detection based on visual features need not be limited to a change between a single consecutive pair of image frames. Rather, the detector 140 may determine that the acoustic environment has been changed responsive to detecting that a visual feature deviates from a base line (e.g. average, median, maximum, minimum) of a number of preceding visual features, by more than a threshold amount. The discussion of the holding parameter h applies correspondingly to the environment change detection based on visual features.

In the above, it has been tacitly assumed that the sequence of time segments tsⱼ of the audio signal A is synchronized with the sequence of image frames vⱼ of the video stream V, such that the time instant of a change in visual features extracted from the sequence of image frames vⱼ may be temporally associated with a specific time segment tsⱼ. It is envisaged that, typically, the temporal rate of the sequence of time segments tsⱼ (e.g. the frame rate of the audio signal A) may exceed the frame rate of the video stream V. Hence, in this case associating every time segment tsⱼ with a respective image frame vⱼ will result in plural possible associations between each image frame vⱼ (or visual feature qⱼ) and the time segments tsⱼ. Alternatively, only a selected subset of regularly spaced time segments tsⱼ of the full sequence of time segments tsⱼ may be associated with each image frame vⱼ (or visual feature qⱼ). The spacing of the selected time segments tsⱼ may be set in correspondence with the frame rate of the video sequence V.

In the following, various implementations and use cases of the method 500 are to be exemplified, wherein it is to be understood that an environment change detection based on acoustic or visual features may be employed.

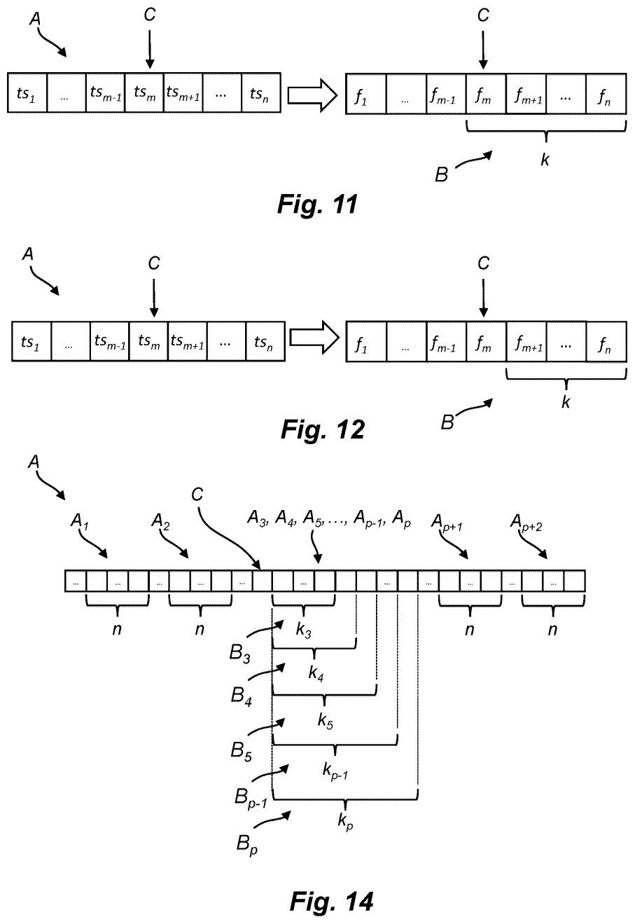

FIG. 11 illustrates an example wherein, upon obtaining the indication of the changed environment (indicated by C), a sequence of n feature sets, extracted from a sequence of n time segments of the audio signal A, has been stored (e.g. in the output buffer (e.g. main memory) of the memory section 120). In other words, a sequence of n feature sets is available to the input pre-processor 150. The base sequence B is formed of k feature sets comprised in the n sets of acoustic features, more specifically k feature sets extracted from time segment tsₘ and onwards. The feature sets extracted from time segments preceding time segment tsₘ may thus be ignored or discarded, for the purpose of the classification. In FIG. 11, it has been assumed that the m-th time segment tsₘ is comprised in the first n time segments (and correspondingly the m-th feature set fₘ is comprised in the first n extracted feature sets). However, this assumption is made merely to facilitate understanding of the concept, and the method is not limited thereto.

FIG. 12 illustrates yet another example, similar to FIG. 11, but where a parameter (e.g. “smoothing factor”) s≥1 (in the illustrated example s=1) is used to delay the starting point of the base sequence B to a feature set fᵥ extracted from a v-th time segment tsv, where v=m+s. In some cases, the feature set fₘ extracted from time segment tsₘ and a number s of successive time segments may be considered unreliable as basis for the acoustic environment classification. The use of a smoothing factor s≥1 hence enables a number of time segments and feature sets to be skipped and hence excluded from the base sequence B. The parameter s may be predetermined (e.g. based on a priori knowledge of the dynamics of environment changes which may be expected) or configured (e.g. based on a user preference). The smoothing factor s may for example be set to a value corresponding to 2 seconds or less of audio duration.

While the examples of FIG. 11-12 refer to a case where specifically a sequence of n feature sets is available to the input pre-processor 150, it is to be noted that a similar approach may be used also if a sequence of more than n feature sets is available to the input pre-processor 150 when the input sequence I is to be formed. In any case, the approaches exemplified in FIG. 11-12 allows the input pre-processor 150 to purposefully select the k feature sets among the available feature sets such that the base sequence B with a greater likelihood may be defined of feature sets exclusively relating to the new environment.

FIG. 13 is a flow chart of a method 600 corresponding to an extension of the method 500, to be described with further reference to FIG. 14, schematically showing a sequence of time segments tsⱼ of an audio signal A.

Steps S602 and S604 of the method 600 generally correspond to steps S202 and S204 of the method 300 of FIG. 6. Accordingly, at step S602 time segments tsⱼ of an audio signal A (or a portion thereof) is received by the input interface 110 of the classification system 100. At step S604, the feature extractor 130 extracts feature sets fⱼ from the received time segments tsⱼ.

While the steps of receiving the audio signal A (S602) and extracting feature sets (S604) are shown as sequential steps at an initial stage of the method, it is to be understood that time segments tsⱼ may be received and feature sets fⱼ may be extracted ongoing in parallel to the subsequently presented steps of the method 600, i.e. S606, S608 and onwards.

Step S606 and FIG. 14 shows that a plurality of classifications (referred to as “preceding classifications” below) may be iteratively performed for a corresponding number of respective temporal portions Aᵢ of the audio signal A (e.g. in FIG. 14 temporal portions A₁ and A₂) preceding the m-th time segment tsm (which like in the method 500 represents the time segment corresponding to the time instant of the environment change detection). Each of the preceding classifications (e.g. i=1, 2) may comprise forming of a respective input sequence Iᵢ of n sets of feature sets fⱼ extracted from the time segments tsⱼ of the respective temporal portion Aᵢ, and generating by the classifier 160 a respective prediction Pᵢ of the acoustic environment using the n sets of acoustic features of the respective input sequence Iᵢ. While in principle, each respective input sequence Iᵢ may be formed in accordance with either the first mode or the second mode as set out above, it will for illustrative purposes be assumed that each of the preceding classifications are performed in accordance with the first mode (i.e. the “normal mode”). This implies that while performing the preceding classifications, enough audio data is available for the classifier 160 to generate a prediction without relying on the second mode. In other words, the classification system 100 is neither constrained in terms of available memory or audio input duration.

At this stage of the method 600, in absence of any indication of a changed environment detection (e.g. by the environment change detector 140), the interval between successive classifications may be relatively long (a low repetition frequency). The computation and memory resources utilized by the classification system 100 may hence be limited, thus preserving power. As per the illustrated example, the interval of the preceding classifications may be such that there is no overlap between the respective temporal portions A₁ and A₂, and hence no overlap between or re-use of the feature sets fⱼ of the respective input sequences I₁ and I₂.

At step S608 (corresponding to step S506 of the method 500), the environment change detector 140 obtains an indication that the acoustic environment is changed at a time instant corresponding to (e.g. coinciding or overlapping with) an m-th time segment tsⱼ₌ₘ of the received sequence of time segments tsⱼ of the audio signal A, and is maintained for a threshold number h≥1 of time segments ts_{j>m} following time segment tsₘ. In FIG. 14, the timing of the environment change relative the sequence of time segments tsⱼ is indicated by C. The change C thus occurs between the second and third temporal portions A₂ and A₃. This is however merely an example and the change may of course occur at any point of the audio signal A. The above discussion of step S506 applies correspondingly to step S608.

At step S610, the method 600 accordingly initiates a loop of iteratively performing a plurality of updated classifications relating to the new environment. The environment change detection C may hence be used to trigger the iterative loop of performing updated classifications. The classification of the first iteration of this loop (e.g. which in the illustrated example of FIG. 14 corresponds to the classification for the temporal portion Aᵢ₌₃) proceeds analogous to steps S508 and S510 above. That is, the input pre-processor 150 forms an input sequence Iᵢ₌₃ as set out for step S206 of the method 200, but where the base sequence Bᵢ₌₃ is defined by kᵢ₌₃ sets of feature sets fem extracted from kᵢ₌₃ time segments tsjem subsequent to the m-th time segment. Accordingly, also the auxiliary sequence Cᵢ₌₃, and thus the input sequence Iᵢ₌₃, is formed of feature sets fem extracted from time segments tspm relating to the new environment. The input sequence Iᵢ₌₃ is provided as input to the classifier 160, wherein the classifier 160 generates a prediction Pᵢ₌₃ based on the feature sets f_{j≥m} of the input sequence Iᵢ₌₃. Here it has for simplicity been assumed that no smoothing parameter s is used (the base sequence Bᵢ₌₃ thus including feature set fⱼ₌ₘ) but the method 600 may also be used with a non-zero smoothing parameter s.

The successive updated classifications of the loop (e.g. in FIG. 14 the classifications for temporal portions A_{i=4, 5, . . . p-1, p}) each comprise:
by the input pre-processor 150:
defining a respective base sequence Bᵢ of kᵢ feature sets fⱼ,
defining a respective auxiliary sequence Cᵢ of dᵢ feature sets fⱼ formed by one or more further instances of one or more of the kᵢ feature sets of the respective base sequence Bᵢ, wherein k_{i<n} and dᵢ=n−kᵢ, and
combining the respective base sequence Bᵢ and the respective auxiliary sequence Cᵢ to form a respective input sequence Iᵢ of n feature sets fⱼ, and
by the classifier 160, generating an updated prediction of the acoustic environment using the n feature sets fⱼ of the respective input sequence Iᵢ as input.

The base sequences Bᵢ used for each successive updated classification (e.g. the updated classifications of iterations i=4, 5, . . . p−1, p) of the loop may however be formed in a different manner than the base sequence Bᵢ of the first iteration of the loop (e.g. i=3). As shown in FIG. 14, base sequences Bᵢ of the updated classifications (e.g. B_{i=4, 5. ... p-1, p}) are formed of feature sets fⱼ extracted from time segments tsⱼ of overlapping temporal portions Aᵢ (e.g. A_{i=4, 5, ... p-1, p}). More specifically, each respective base sequence Bᵢ (e.g. B_{i=4, 5, ... p-1, p}) comprises the kᵢ₋₁ feature sets fⱼ of the respective base sequence Bᵢ₋₁ of the previous iteration i−1, and one or more further feature sets fⱼ extracted from one or more later time segments tsⱼthan the kᵢ₋₁ feature sets of the base sequence Bᵢ₋₁ of the previous iteration i−1.

In the illustrated example of FIG. 14, the interval or repetition frequency of the iteratively performed classifications S610 of the loop, is such that a single feature set fⱼ is added to the base sequence Bᵢ of iteration i, relative the base sequence Bᵢ₋₁ of the previous iteration. This means that the length of the base sequences Bᵢ (e.g. B_{i=4, 5, ... p-1, p}) is increased by one feature set fⱼ in each iteration. However, this is merely an example and a smaller overlap between the temporal portions Aᵢ and feature sets fⱼ is also possible. The number of further feature sets fⱼ added to the base sequence Bᵢ of each successive classification may typically be constant. In any case, it may be noted that the interval or repetition frequency may be increased relative the preceding classifications and thus reduce the delay in classifying the new environment.

By the iterative loop of step S610 following step S608, a number of successive updated predictions of the audio environment may be provided, wherein each prediction is based on an input sequence Iᵢ derived using a base sequence Bᵢ of a progressively increasing number kᵢ of feature sets fⱼ relating to the new environment. It is envisaged that this approach may be advantages in a streaming or real-time audio capturing scenario, wherein the updated classifications (in the form of predictions P_{i=4, 5, . . . p-1, p}) may be provided as further time segments ts_{j>m} relating to the new environment are processed by the feature extractor 130.

The loop of step S610 may proceed until, in a final iteration (e.g. i=p), a respective input sequence Iₚ of n sets of acoustic features extracted from a sequence of n time segments may be defined. In other words, the method may be iterated until a base sequence Bₚ of length n is defined, wherein the base sequence Bₚ may be directly used as the input sequence as it already includes the number of feature sets fⱼ expected by the classifier 160.

As shown in FIGS. 13 and 14, the method 600 may at step S612, subsequent to concluding the loop of step S610, continue by (again) iteratively performing further classifications of respective temporal portions Aᵢ of the audio signal A (e.g. A_{i=p, p+1 . . .} ). These further classifications may analogous to the discussion of the preceding classifications of A₁and A₂ be performed at a relatively long interval (a low repetition frequency) such that the temporal portions A_{i=p, p+1} do not overlap. The above discussion of step S606 applies correspondingly to step S612.

Systems and methods disclosed in the present application may be implemented as software, firmware, hardware or a combination thereof. In a hardware implementation, the division of tasks does not necessarily correspond to the division into physical units; to the contrary, one physical component may have multiple functionalities, and one task may be carried out by several physical components in cooperation.

The computer hardware may for example be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions (sequential or otherwise) that specify actions to be taken by that computer hardware. Further, the present disclosure shall relate to any collection of computer hardware that individually or jointly execute instructions to perform any one or more of the concepts discussed herein.

Certain or all components may be implemented by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system (i.e. a computer hardware) that includes one or more processors. Each processor may include one or more of a CPU, a graphics processing unit, and a programmable DSP unit. The processing system further may include a memory subsystem including a hard drive, SSD, RAM and/or ROM. A bus subsystem may be included for communicating between the components. The software may reside in the memory subsystem and/or within the processor during execution thereof by the computer system.

The one or more processors may operate as a standalone device or may be connected, e.g., networked to other processor(s). Such a network may be built on various different network protocols, and may be the Internet, a Wide Area Network (WAN), a Local Area Network (LAN), or any combination thereof.

The software may be distributed on computer readable media, which may comprise computer storage media (or non-transitory media) and communication media (or transitory media). As is well known to a person skilled in the art, the term computer storage media includes both volatile and non-volatile, removable and non-removable media implemented in any method or technology for storage of information such as computer readable instructions, data structures, program modules or other data. Computer storage media includes, but is not limited to, physical (non-transitory) storage media in various forms, such as EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Further, it is well known to the skilled person that communication media (transitory) typically embodies computer readable instructions, data structures, program modules or other data in a modulated data signal such as a carrier wave or other transport mechanism and includes any information delivery media.

Various aspects of the present disclosure may be appreciated from the following Enumerated Example Embodiments (EEEs):

EEE 1. A method for acoustic environment classification using a classifier trained to, given an input formed of a sequence of n sets of acoustic features, output a prediction of an acoustic environment of an audio signal, the method comprising: extracting sets of acoustic features from the audio signal, wherein each set of acoustic features comprises one or more types of acoustic features and is extracted from a respective time segment of a sequence of time segments of the audio signal; forming an input sequence of n sets of acoustic features, wherein forming the input sequence comprises: defining a base sequence of k of the extracted sets of acoustic features, defining an auxiliary sequence of d sets of acoustic features formed by one or more further instances of one or more of the k sets of acoustic features of the base sequence, wherein k<n and d=n−k, and combining the base sequence and the auxiliary sequence to form the input sequence of n sets of acoustic features; and generating by the classifier a prediction of the acoustic environment using the n sets of acoustic features of the input sequence as input.

EEE 2. The method according to EEE 1, wherein the sets of acoustic features of the auxiliary sequence are appended and/or prepended to the base sequence.

EEE 3. The method according to any one of EEEs 1-2, wherein the base sequence is formed by k consecutively extracted sets of acoustic features, and wherein the auxiliary sequence comprises one or more sub-sequences formed of instances of the consecutively extracted sets of acoustic features of the base sequence.

EEE 4. The method according to any one of the preceding EEEs, wherein if k≥n/2, the auxiliary sequence is formed by one further instance of at least a sub-sequence of the base sequence, the number of sets of acoustic features of said at least a sub-sequence being d; or if k<n/2, the auxiliary sequence is formed by x−1 further instances of the base sequence and one further instance of a sub-sequence of y sets of acoustic features of the base sequence, wherein x is the greatest divisor of n and y is the remainder of n/k.

EEE 5. The method according to any one of the preceding EEEs, further comprising receiving k time segments of the audio signal, wherein extracting the sets of acoustic features comprises extracting by a feature extractor a sequence of k sets of acoustic features from the k received time segments, and wherein the base sequence is formed by the sequence of k sets of acoustic features extracted by the feature extractor.

EEE 6. The method according to EEE 5, wherein the received k time segments corresponds to the duration of the audio signal, or to a memory capacity available for storing the audio signal and/or extracted sets of acoustic features.

EEE 7. The method according to any one of the preceding EEEs, wherein the method comprises iteratively performing classifications of the audio signal, wherein each classification relates to a respective temporal portion of the audio signal and comprises:

forming a respective input sequence of n sets of acoustic features; and generating by the classifier a respective prediction of the acoustic environment for the respective temporal portion of the audio signal using the n sets of acoustic features of the respective input sequence as input; wherein for each classification i, the respective input sequence is formed in accordance with either a first mode or a second mode: wherein, according to the first mode, the respective input sequence is formed by n sets of acoustic features extracted from a sequence of n time segments of the respective temporal portion of the audio signal, and wherein, according to the second mode, the respective input sequence is formed by: defining a respective base sequence of ki sets of acoustic features extracted from a sequence of kᵢ<n time segments of the respective temporal portion of the audio signal, defining a respective auxiliary sequence of dᵢ=n−kᵢ sets of acoustic features formed by one or more further instances of one or more of the kᵢ sets of acoustic features of the respective base sequence, and combining the respective base sequence and auxiliary sequence to form the respective input sequence.

EEE 8. The method according to EEE 7, wherein each classification further comprises determining whether to form the respective input sequence in accordance with either the first or second mode based on a duration of the respective temporal portion and/or an available memory capacity for storing the respective temporal portion and/or extracted acoustic features.

EEE 9. The method according to any one of the preceding EEEs, further comprising obtaining an indication that an acoustic environment of the audio signal is changed from a previous to a new acoustic environment at a time instant corresponding to an m-th time segment of the audio signal, and is maintained for a threshold number h≥1 of time segments; wherein the k sets of acoustic features of the base sequence are extracted from k time segments from the m-th time segment of the audio signal and onwards, or subsequent to the m-th time segment of the audio signal.

EEE 10. The method according to EEE 9, wherein the k sets of acoustic features of the base sequence are extracted from k time segments starting from a v-th time segment of the audio signal, wherein v=m+s, and s is a predetermined or configurable parameter equal to or greater than 1.

EEE 11. The method according to any one of EEEs 9-10, wherein, upon obtaining the indication of the changed environment, a sequence of at least n sets of acoustic features has been extracted from a sequence of n time segments of the audio signal, wherein the m-th time segment is comprised in the sequence of n time segments, and wherein the base sequence is formed of k sets of acoustic features comprised in the n sets of acoustic features.

EEE 12. The method according to any one of EEEs 9-11, wherein the steps of forming the input sequence and generating the prediction are performed as part of a first classification of a temporal portion of the audio signal relating to the new environment, and wherein the method further comprises, subsequent to the first classification, iteratively performing a plurality of updated classifications relating to the new environment, each comprising: defining a respective base sequence of kᵢ sets of acoustic features, defining a respective auxiliary sequence of dᵢ sets of acoustic features formed by one or more further instances of one or more of the kᵢ sets of acoustic features of the respective base sequence, wherein kᵢ<n and dᵢ=n−kᵢ, combining the respective base sequence and the respective auxiliary sequence to form a respective input sequence of n sets of acoustic features, and generating by the classifier an updated prediction of the acoustic environment using the n sets of acoustic features of the updated input sequence as input; wherein the respective base sequence of kᵢ sets of acoustic features of each successive updated classification i comprises the kᵢ₋₁ sets of acoustic features of the respective base sequence of the previous classification i−1 and one or more further sets of acoustic features extracted from one or more later time segments than the kᵢ₋₁ sets of acoustic features of the respective base sequence of the previous classification i−1.

EEE 13. The method according to EEE 12, wherein the updated classifications are iteratively performed until, in a final iteration, a respective input sequence of n sets of acoustic features extracted from a sequence of n time segments has been defined.

EEE 14. The method according to any one of EEEs 12-13, further comprising, prior to obtaining the indication of the changed environment, iteratively performing a plurality of preceding classifications of the acoustic environment for a corresponding number of respective temporal portions of the audio signal preceding the m-th time segment, wherein each preceding classification comprises: forming a respective input sequence of n sets of acoustic features extracted from time segments of the respective temporal portion of the audio signal; and generating by the classifier a respective prediction of the acoustic environment using the n sets of acoustic features of the respective input sequence as input; wherein an interval between the updated classifications is reduced compared to an interval between the preceding classifications.

EEE 15. The method according to EEE 14, wherein the interval of the preceding classifications is such that there is no overlap between sets of acoustic features of the respective input sequences.

EEE 16. The method according to any one of EEEs 9-15, wherein obtaining the indication of the changed environment comprises determining a change of an acoustic feature between the m-th time segment and a previous time segment.

EEE 17. The method according to EEE 16, wherein the acoustic feature comprises a changed noise level and/or energy level between the m-th time segment and the previous time segment.

EEE 18. A method according to any one of EEEs 9-15 further comprising: obtaining the audio signal by a user device via a microphone system comprising one or more microphones; obtaining via a camera of the user device, a sequence of image frames simultaneous to obtaining the audio signal; and extracting a visual feature from each image frame; wherein obtaining the indication of the changed environment comprises determining a change of the visual feature between image frames corresponding to the m-th time segment and a previous time segment of the audio signal.

EEE 19. A method for processing an audio signal, comprising: obtaining an audio signal; classifying an acoustic environment of the audio signal using the method according to any one of the preceding claims, thereby generating a prediction of the acoustic environment; and processing the audio signal using an audio processing stage having at least one adjustable control parameter, wherein the at least one control parameter is set in dependence on the prediction of the acoustic environment.

EEE 20. The method of EEE 19, wherein the audio processing stage is configured to implement at least one of: noise reduction, dialogue enhancement, event detection and sound object extraction.

EEE 21. A computer program product comprising computer program code to perform, when executed on a computer, the method according to any of the preceding EEEs.

EEE 22. A system for acoustic environment classification, comprising: a classifier trained to, given an input formed of a sequence of n sets of acoustic features, output a prediction of an acoustic environment of an audio signal; a feature extractor configured to extract sets of acoustic features from the audio signal, wherein each set of acoustic features comprises one or more types of acoustic features and is extracted from a respective time segment of a sequence of time segments of the audio signal; an input pre-processor configured to form an input sequence of n sets of acoustic features and provide the input sequence as input to the classifier to generate a prediction of the acoustic environment, wherein the input pre-processor is configured to form the input sequence by: defining a base sequence of k sets of acoustic features extracted by the feature extractor, defining an auxiliary sequence of d sets of acoustic features formed by one or more further instances of one or more of the k sets of acoustic features of the base sequence, wherein k<n and d=n−k, and combining the base sequence and the auxiliary sequence to form the input sequence of n sets of acoustic features.

1. A method for acoustic environment classification using a classifier trained to, given an input formed of a sequence of n sets of acoustic features, output a prediction of an acoustic environment of an audio signal, the method comprising:
extracting sets of acoustic features from the audio signal, wherein each set of acoustic features comprises one or more types of acoustic features and is extracted from a respective time segment of a sequence of time segments of the audio signal;
forming an input sequence of n sets of acoustic features, wherein forming the input sequence comprises:
defining a base sequence of k of the extracted sets of acoustic features,
defining an auxiliary sequence of d sets of acoustic features formed by one or more further instances of one or more of the k sets of acoustic features of the base sequence, wherein k<n and d=n−k, and
combining the base sequence and the auxiliary sequence to form the input sequence of n sets of acoustic features; and
generating by the classifier a prediction of the acoustic environment using the n sets of acoustic features of the input sequence as input.

2. The method according to claim 1, wherein the sets of acoustic features of the auxiliary sequence are appended and/or prepended to the base sequence.

3. The method according to claim 1, wherein the base sequence is formed by k consecutively extracted sets of acoustic features, and wherein the auxiliary sequence comprises one or more sub-sequences formed of instances of the consecutively extracted sets of acoustic features of the base sequence.

4. The method according to claim 1, wherein
if k≥n/2, the auxiliary sequence is formed by one further instance of at least a sub-sequence of the base sequence, the number of sets of acoustic features of said at least a sub-sequence being d; or
if k<n/2, the auxiliary sequence is formed by x−1 further instances of the base sequence and one further instance of a sub-sequence of y sets of acoustic features of the base sequence, wherein x is the greatest divisor of n and y is the remainder of n/k.

5. The method according to claim 1, further comprising receiving k time segments of the audio signal, wherein extracting the sets of acoustic features comprises extracting by a feature extractor a sequence of k sets of acoustic features from the k received time segments, and wherein the base sequence is formed by the sequence of k sets of acoustic features extracted by the feature extractor.

6. The method according to claim 5, wherein the received k time segments corresponds to the duration of the audio signal, or to a memory capacity available for storing the audio signal and/or extracted sets of acoustic features.

7. The method according to claim 1, wherein the method comprises iteratively performing classifications of the audio signal, wherein each classification relates to a respective temporal portion of the audio signal and comprises:
forming a respective input sequence of n sets of acoustic features; and
generating by the classifier a respective prediction of the acoustic environment for the respective temporal portion of the audio signal using the n sets of acoustic features of the respective input sequence as input;
wherein for each classification i, the respective input sequence is formed in accordance with either a first mode or a second mode:
wherein, according to the first mode, the respective input sequence is formed by n sets of acoustic features extracted from a sequence of n time segments of the respective temporal portion of the audio signal, and wherein, according to the second mode, the respective input sequence is formed by: defining a respective base sequence of ki sets of acoustic features extracted from a sequence of kᵢ<n time segments of the respective temporal portion of the audio signal, defining a respective auxiliary sequence of dᵢ=n−kᵢ sets of acoustic features formed by one or more further instances of one or more of the kᵢ sets of acoustic features of the respective base sequence, and combining the respective base sequence and auxiliary sequence to form the respective input sequence.

8. The method according to claim 7, wherein each classification further comprises determining whether to form the respective input sequence in accordance with either the first or second mode based on a duration of the respective temporal portion and/or an available memory capacity for storing the respective temporal portion and/or extracted acoustic features.

9. The method according to claim 1, further comprising obtaining an indication that an acoustic environment of the audio signal is changed from a previous to a new acoustic environment at a time instant corresponding to an m-th time segment of the audio signal, and is maintained for a threshold number h≥1 of time segments;
wherein the k sets of acoustic features of the base sequence are extracted from k time segments from the m-th time segment of the audio signal and onwards, or subsequent to the m-th time segment of the audio signal.

10. The method according to claim 9, wherein the k sets of acoustic features of the base sequence are extracted from k time segments starting from a v-th time segment of the audio signal, wherein v=m+s, and s is a predetermined or configurable parameter equal to or greater than 1.

11. The method according to claim 9, wherein, upon obtaining the indication of the changed environment, a sequence of at least n sets of acoustic features has been extracted from a sequence of n time segments of the audio signal, wherein the m-th time segment is comprised in the sequence of n time segments, and wherein the base sequence is formed of k sets of acoustic features comprised in the n sets of acoustic features.

12. The method according to claim 9, wherein the steps of forming the input sequence and generating the prediction are performed as part of a first classification of a temporal portion of the audio signal relating to the new environment, and wherein the method further comprises, subsequent to the first classification, iteratively performing a plurality of updated classifications relating to the new environment, each comprising:
defining a respective base sequence of kᵢ sets of acoustic features, defining a respective auxiliary sequence of dᵢ sets of acoustic features formed by one or more further instances of one or more of the kᵢ sets of acoustic features of the respective base sequence, wherein kᵢ<n and dᵢ=n−kᵢ,
combining the respective base sequence and the respective auxiliary sequence to form a respective input sequence of n sets of acoustic features, and
generating by the classifier an updated prediction of the acoustic environment using the n sets of acoustic features of the updated input sequence as input;
wherein the respective base sequence of kᵢ sets of acoustic features of each successive updated classification i comprises the kᵢ₋₁ sets of acoustic features of the respective base sequence of the previous classification i−1 and one or more further sets of acoustic features extracted from one or more later time segments than the kᵢ₋₁ sets of acoustic features of the respective base sequence of the previous classification i−1.

13. The method according to claim 12, wherein the updated classifications are iteratively performed until, in a final iteration, a respective input sequence of n sets of acoustic features extracted from a sequence of n time segments has been defined.

14. The method according to claim 12, further comprising, prior to obtaining the indication of the changed environment, iteratively performing a plurality of preceding classifications of the acoustic environment for a corresponding number of respective temporal portions of the audio signal preceding the m-th time segment, wherein each preceding classification comprises:
forming a respective input sequence of n sets of acoustic features extracted from time segments of the respective temporal portion of the audio signal; and
generating by the classifier a respective prediction of the acoustic environment using the n sets of acoustic features of the respective input sequence as input;
wherein an interval between the updated classifications is reduced compared to an interval between the preceding classifications.

15. The method according to claim 14, wherein the interval of the preceding classifications is such that there is no overlap between sets of acoustic features of the respective input sequences.

16. The method according to claim 9, wherein obtaining the indication of the changed environment comprises determining a change of an acoustic feature between the m-th time segment and a previous time segment.

17. The method according to claim 16, wherein the acoustic feature comprises a changed noise level and/or energy level between the m-th time segment and the previous time segment.

18. A method according to claim 9, further comprising:
obtaining the audio signal by a user device via a microphone system comprising one or more microphones;
obtaining via a camera of the user device, a sequence of image frames simultaneous to obtaining the audio signal; and
extracting a visual feature from each image frame;
wherein obtaining the indication of the changed environment comprises determining a change of the visual feature between image frames corresponding to the m-th time segment and a previous time segment of the audio signal.

19. A method for processing an audio signal, comprising:
obtaining an audio signal;
classifying an acoustic environment of the audio signal using the method according to any one of the preceding claims, thereby generating a prediction of the acoustic environment; and
processing the audio signal using an audio processing stage having at least one adjustable control parameter, wherein the at least one control parameter is set in dependence on the prediction of the acoustic environment.

20. The method of claim 19, wherein the audio processing stage is configured to implement at least one of: noise reduction, dialogue enhancement, event detection and sound object extraction.

21. (canceled)

22. (canceled)
